(19) United States
(12) Patent Application Publication
(10) Pub. No.: US 2006/0131367 A1
(43) Pub. Date: Jun. 22, 2006

(54) Low thermal resistance junction processing

(76) Inventor: Frederick Lee, Hsinchu City (TW)

Correspondence Address: LEONG C LEI, PMB # 1008, 1867 YGNACIO VALLEY ROAD, WALNUT CREEK, CA, 94598, US

(21) Appl. No.: 11/016,958

(22) Filed: Dec. 21, 2004

(51) Int. Cl. B23K 31/00

(52) U.S. Cl. 228/248.1

(57) ABSTRACT

A method for reducing thermal resistance at a junction between two types of metallic material is provided. The method mainly forms a capillary structure between the two surfaces of the two identical or different types of metallic material. The method then adds and melts an appropriate amount of soldering paste at the junction so as to bind the two types of metallic material together. The invention could achieve superior structural strength and thermal conductivity at the junction.

### BACKGROUND OF THE INVENTION

(a) Technical Field of the Invention

The present invention generally relates to metallic junctions, and more particularly to a method for reducing the thermal resistance at metallic junctions.

(b) Description of the Prior Art

As the performance of semiconducting chips is continuously climbing, heat dissipation has caught the attention of the chip makers and system integrators alike. Effective heat dissipation is crucial to the high performance chips' normal functioning and operation life. Well-designed heat dissipating mechanisms could also help reducing the dimensions of the electronic devices using these high performance chips, making these electronic devices smaller and lighter. Therefore, people are aggressively searching for even more effective heat dissipating technologies.

When a junction is required and formed between two identical or different types of metallic material (such as copper, aluminum, etc.), there are two conventional approaches for improving the thermal conductivity across the junction. One approach is to use pressure perpendicular to the junction to compress the two types of material tightly together, as shown in FIG. 1. However, as the surface roughness of the two types of material 101a and 101b are difficult to control, there are often voids 101c left in the junction between the two types of material 101a and 101b. As such, the thermal resistance in this compression-type junction could not be reduced effectively. The other approach is to use soldering paste 102d to bind the two types of material 102a and 102b together, as shown in FIG. 2. When the soldering paste 102d is melted by increasing temperature, the melted soldering paste 102d tends to cluster at places having smaller curvature due to the surface tension. In addition, since the solder fluxes (not shown) are often depleted during the process, soldering paste 102d stays only within smaller gaps when temperature drops. Larger gaps thereby form voids 102c of various sizes. Again, there is only limited improvement to the thermal resistance across the junction and to the structural strength at the junction.

Accordingly, there is a need for a better way to enhance the thermal conductivity and structural strength at the junction between two types of metallic material.

### SUMMARY OF THE INVENTION

The primary purpose of the present invention is to provide a method for reducing junction thermal resistance so that two identical or different types of metallic material could be bound together with enhanced structural strength and airtightness.

To achieve the foregoing objectives, the present invention mainly forms a capillary structure at the junction between two identical or different types of metallic material. The present invention then adds an appropriate amount of soldering paste at the junction. The soldering paste is then melted to bind the two types of material together. Due to the capillarity effect, the melted soldering paste has better wettability on the metallic surfaces so that the melted soldering paste flows and distributes more uniformly at the junction. When the temperature drops, the junction could achieve a better structural strength and airtightness. The junction's thermal resistance is thereby reduced and its thermal conductivity could be fully utilized.

The foregoing capillary structure is formed by developing regularly or irregularly, interlacing or non-interlacing cannelures on the metallic junction surfaces by using a sand blasting, scratching, cutting, roll forming, or thermocompressing process. The capillary structure could also be formed by interposing metallic powders or a metallic grid between the two types of metallic material. The metallic powders or the metallic grid could be sintered or welded to the junction surface of one or both types of metallic material in advance.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional schematic view showing a conventional junction.

FIG. 2 is a cross-sectional schematic view showing another conventional junction.

FIG. 3 is a cross-sectional schematic view showing a capillary structure formed in the junction on the surfaces of the two types of material according to the present invention.

FIG. 4 is a cross-sectional schematic view showing a capillary structure formed in the junction on one of the surfaces of the two types of material according to the present invention.

FIG. 5 is a cross-sectional schematic view showing a capillary structure of regular cannelures formed by cutting, roll forming, stamping, or themocompressing on one of the surfaces of the two types of material according to the present invention.

FIG. 6 is a top schematic view showing a capillary structure of regularly patterned cannelures formed by roll forming, stamping, or themocompressing on one of the surfaces of the two types of material according to the present invention.

FIG. 7 is a top schematic view showing a capillary structure of regularly interlacing linear cannelures formed by cutting, roll forming, stamping, or themocompressing on one of the surfaces of the two types of material according to the present invention.

FIG. 8 is a top schematic view showing a capillary structure of repetitively patterned cannelures formed by roll forming, stamping, or themocompressing on one of the surfaces of the two types of material according to the present invention.

FIG. 9 is a cross-sectional schematic view showing a capillary structure layer formed by metallic powders according to the present invention.

FIG. 10 is a cross-sectional schematic view showing a capillary structure layer formed by a metallic grid according to the present invention.

FIG. 11 is a cross-sectional schematic view showing an application of the present invention between curved surfaces in the junction.

FIG. 12 shows an application scenario of the present invention.

FIG. 13 shows an application scenario of the present invention.

FIG. 14 shows an application scenario of the present invention.

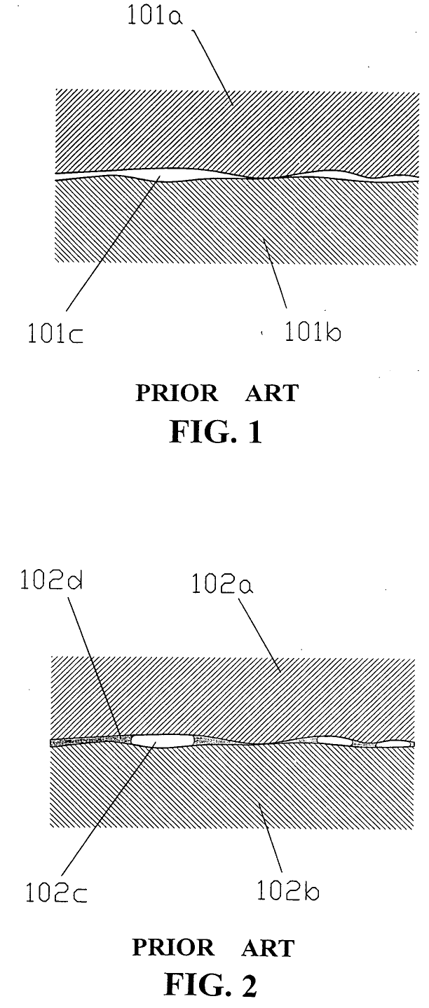

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, detailed description along with the accompanied drawings is given to better explain preferred embodiments of the present invention.

In a preferred embodiment of the present invention, a capillary structure is formed at the junction between two identical or different types of metallic material. An appropriate amount of soldering paste is then added in the junction and melted to bind the two types of material together.

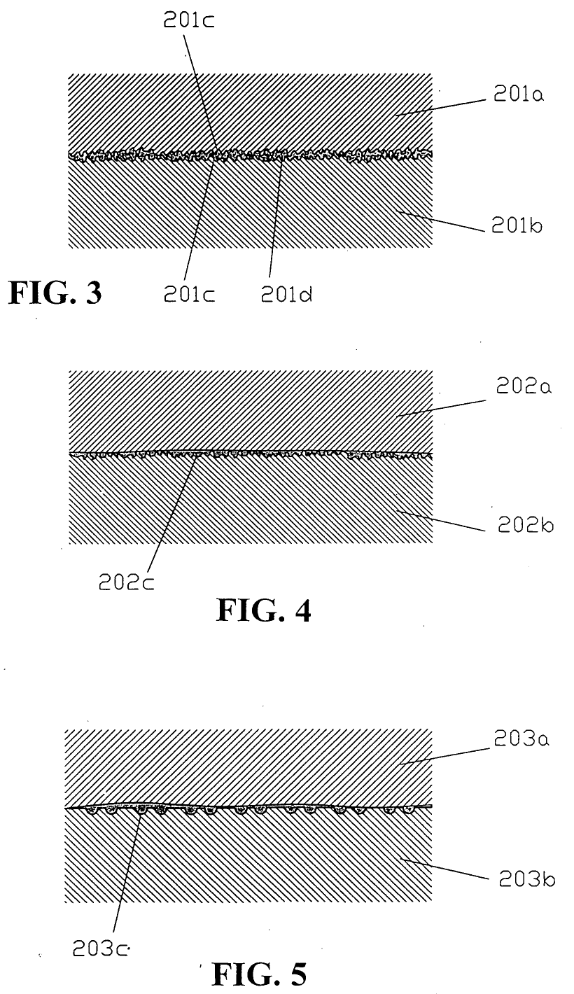

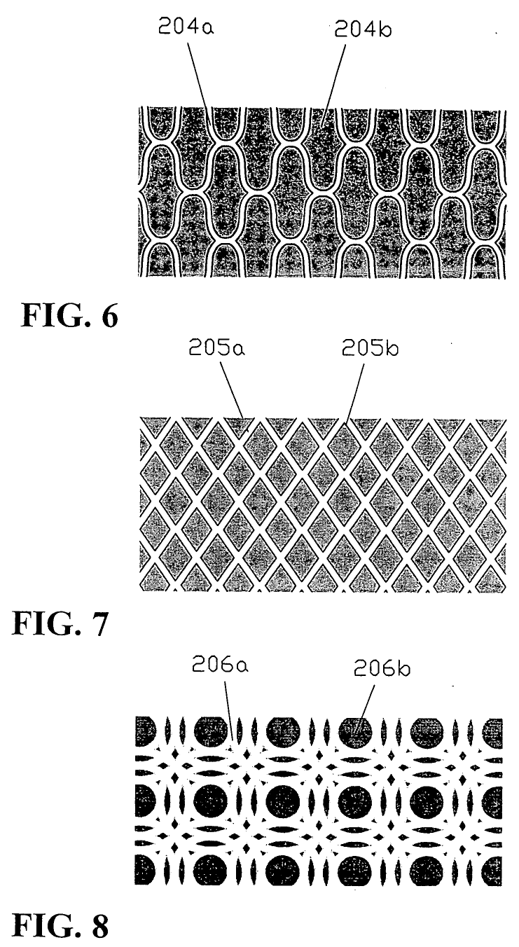

The capillary structure 201c could be formed on the surfaces of both types of material 201a and 201b, as shown in FIG. 3, or the capillary structure 202c could be formed on the surface of only one of the two types of material 202a and 202b, as shown in FIG. 4. In either way, the capillary structure could be formed using sand blasting to generate irregularly distributed miniature holes and bumps, as shown in FIGS. 3 and 4. In an alternative embodiment of the present invention, the capillary structure 203c is formed using scratching by tools such as emery paper, emery wheel, metallic brush, etc. to generate interlacing or non-interlacing cannelures on the surfaces of the two types of material 203a and 203b, as shown in FIG. 5. Similarly, cutting with various kinds of cutters could also be used to generate cannelures of various depths. The difference between scratching and cutting is that cutting, as shown in FIG. 7, could generate regular- or irregular-arranged interlacing cannelures 205a on the surface 205b. In other embodiments of the present invention, roll forming, stamping, and thermocompressing with various molds could generate regularly-arranged interlacing or non-interlacing cannelures 204a, 205, and 206a, of repetitive patterns on the surfaces 204b, 205b, and 206b, as shown in FIGS. 6, 7, and 8. The soldering paste 201d added in the junction as shown in FIG. 3 is also be used in these embodiments of the present invention. The soldering paste 201d could be tin/lead based material or non-lead based material such as tin/silver/copper.

In all the foregoing embodiments of the present invention, the capillary structure enhances the wettability of the melted soldering paste on the metallic surfaces, causing a uniform distribution of the melted soldering paste in the junction. Therefore, when the temperature drops, superior structural strength and airtightness at the junction could be achieved, the thermal resistance at the junction could be lowered to the minimum, and the thermal conductivity of the junction could be fully utilized. Please be noted that, if the cannelures are more densely interlaced, the melted soldering paste could have an even more uniform distribution.

There are also some embodiments of the present invention form a capillary structure layer at the junction between two identical or different types of metallic material. An appropriate amount of soldering paste is then added in the junction and melted to bind the two types of material together.

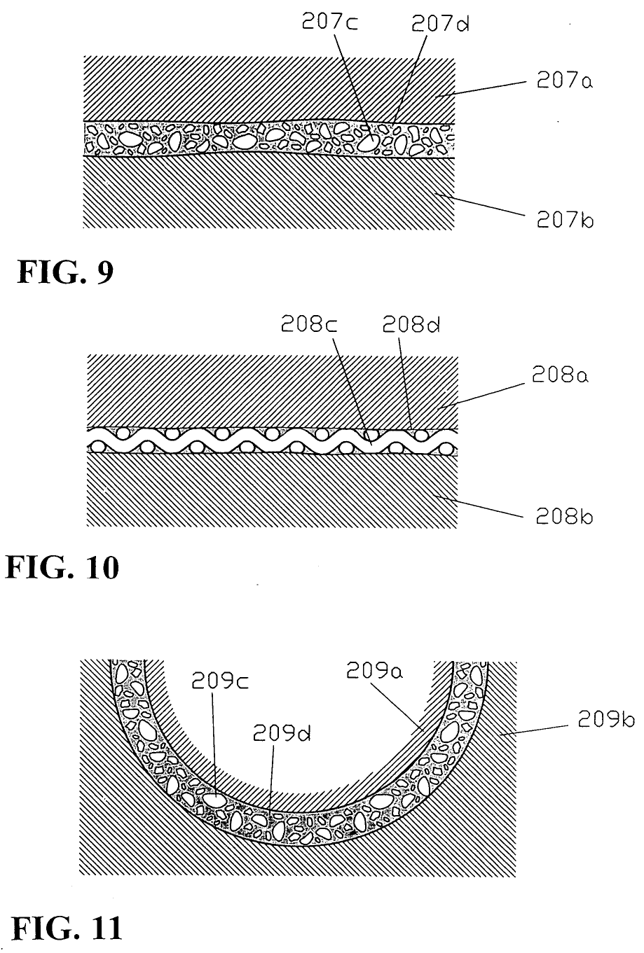

The capillary structure layer could be formed by interposing an appropriate amount of metallic powders 207c of a third type of metallic material between the two types of metallic material 207a and 207b, as shown in FIG. 9, or by interposing a metallic grid 208c of a third type of metallic material between the two types of metallic material 208a and 208b, as shown in FIG. 10. The metallic powder 207c (or the metallic grid 208c) is sintered or welded to the surface of one of the two types of metallic materials 207a and 207b (or 208a and 208b). In a separate embodiment, the metallic powder 207c (or the metallic grid 208c) is sintered or welded to both surfaces of the two types of metallic materials 207a and 207b (or 208a and 208b). The soldering paste 207d and 208d added in the capillary structure layer, as shown in FIG. 10, could be tin/lead based material or non-lead based material such as tin/silver/copper.

The metallic powders 207c and the metallic grid 208c are best made of a metallic material having a high thermal conductivity. The capillary structure layer formed could achieve an identical effect as those embodiments forming capillary structures on the metallic surfaces directly.

The present invention could be implemented in various heat dissipating applications of electronic devices and it is especially ideal for heat dissipating modules of computer chips. In the following, the various scenarios of the application of the present invention are described.

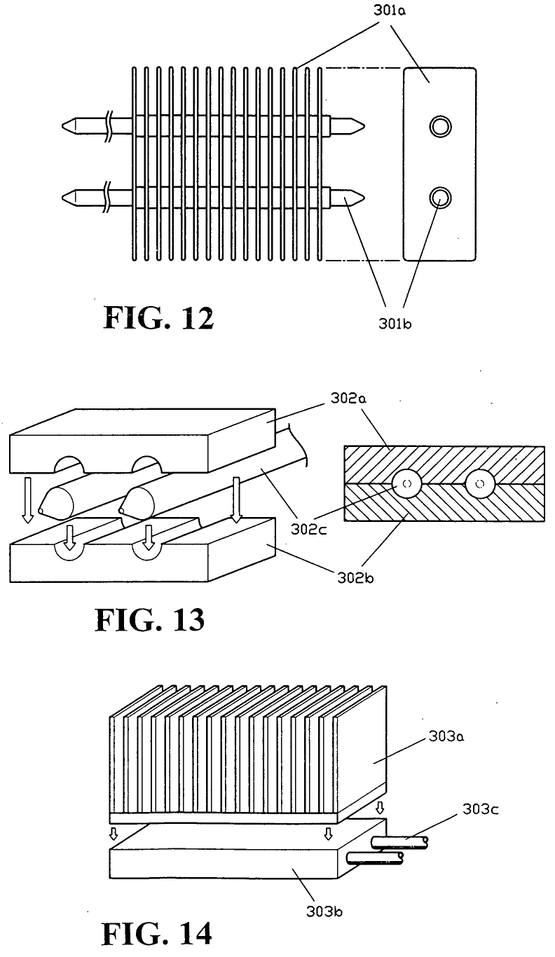

FIG. 12 shows an application scenario of the present invention in the junction between heat dissipating fins 301a and heat pipes 301b. As shown in FIG. 12, the large-area junctions when heat dissipating fins 301a and heat pipes 301b are where the capillary structure of the present invention could be applied.

FIG. 13 shows another application scenario. As shown in FIG. 13, heat pipes 302c are encased by the upper and lower bodies 302a and 302b of a heat sink base. The junctions between the three types of components are where the capillary structure of the present invention could be applied.

FIG. 14 shows yet another application scenario. As shown in FIG. 14, a heat dissipating module contains heat dissipating fins 303a on the top and heat sink base 303b at the bottom. The present invention could be applied to the junction between the heat dissipating fins 303a and the heat sink base 303b. The present invention could also be applied to the junctions between the heat pipes 303c and the heat sink base 303b.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A junction processing for lowering thermal resistance between two types of metallic material comprising the steps of:
forming a capillary structure between surfaces of said two types of metallic material;
adding an appropriate amount of soldering paste between said surfaces; and
melting said soldering paste by increasing temperature so as to bind said two types of metallic material together.

2. The junction processing according to claim 1, wherein said capillary structure is formed using one of the methods consisting of sand blasting, scratching, cutting, roll forming, and thermocompressing to generate cannelures on said surfaces of said two types of metallic material.

3. The junction processing according to claim 2, wherein said cannelures are formed on at least one of said surfaces of said two types of metallic material.

4. The junction processing according to claim 1, wherein said capillary structure is formed by interposing an appropriate amount of metallic powders of a third type of metallic material between said surfaces of said two types of metallic material, attaching said metallic powders to at least one of said surfaces of said two types of metallic material using one of the methods consisting of sintering and welding.

5. The junction processing according to claim 1, wherein said capillary structure is formed by interposing a metallic grid of a third type of metallic material between said surfaces of said two types of metallic material, attaching said metallic grid to at least one of said surfaces of said two types of metallic material using one of the methods consisting of sintering and welding.

6. The junction processing according to claim 1, wherein said soldering paste is one of two types of material consisting of tin/lead based material and tin/silver/copper based material.

7. The junction processing according to claim 1, wherein said surfaces of said two types of material are curved surfaces.
